(19) United States
(12) Patent Application Publication
(10) Pub. No.: US 2025/0047104 A1
(43) Pub. Date: Feb. 6, 2025

(54) POWER MANAGEMENT SYSTEM AND POWER MANAGEMENT METHOD

(71) Applicant: TOYOTA JIDOSHA KABUSHIKI KAISHA, Toyota-shi (JP)

(72) Inventors: Akinori Morishima, Naka-gun (JP); Takafumi Matsumura, Ashiya-shi (JP)

(73) Assignee: TOYOTA JIDOSHA KABUSHIKI KAISHA, Toyota-shi (JP)

(21) Appl. No.: 18/746,444

(22) Filed: Jun. 18, 2024

(30) Foreign Application Priority Data
Aug. 2, 2023 (JP) 2023-125958

(51) Int. Cl. H02J 3/46; G06Q 50/06

(52) U.S. Cl. CPC H02J 3/46; G06Q 50/06

(57) ABSTRACT

The power management system includes HEMS controllers and energy management servers. The power management control includes a plan control that instructs HEMS controller to control HEMS based on the power supply and demand plan, and an edge control that instructs HEMS controller to control HEMS based on the actual status of HEMS surplus power and the demand power. During the planning control, the energy management server instructs HEMS controllers to perform the edge-control while at least one of the sale of the surplus power and the purchase of the demand power is predicted in HEMS.

### CROSS-REFERENCE TO RELATED APPLICATION

This application claims priority to Japanese Patent Application No. 2023-125958 filed on Aug. 2, 2023, incorporated herein by reference in its entirety.

### BACKGROUND

### 1. Technical Field

The present disclosure relates to power management systems and power management methods, and more particularly, to a system and method for managing power supply and demand in a power grid including a plurality of power balancing resources.

### 2. Description of Related Art

Japanese Unexamined Patent Application Publication No. 2016-187254 (JP 2016-187254 A) discloses a method for controlling a storage battery so as to reduce loss of power generated using renewable energy, and a method for controlling a water heater that can be controlled so that power supply does not fall below a minimum required power value. JP 2016-187254 A also describes calculating a prediction error of prediction data using an operation plan data for the storage battery and an actual operation performance data.

### SUMMARY

In a power grid including a plurality of power balancing resources (e.g., a home energy management system that will be described later), there are cases where the actual power supply and demand of a power balancing resource changes according to a power supply and demand plan. Further, in the power grid, electric power may be sold and purchased in the resource, that is, power sale of surplus power and/or power purchase of demand power (insufficient electric power) may be performed. When the electric power is sold and purchased in this way, it is desirable that a burden on a user of the resource is reduced.

The present disclosure was made to solve the above issue, and an object of the present disclosure is to reduce a user burden when electric power is sold and purchased in a power balancing resource.

A power management system according to an aspect of the present disclosure manages power supply and demand in a power grid including a plurality of power balancing resources. The power management system includes:
a controller that controls a corresponding resource that is a corresponding one of the power balancing resources; and
a server that sets power management control to be performed on the corresponding resource by the controller.

The power management control includes a first control instructing the controller to control the corresponding resource based on a power supply and demand plan developed in advance, and a second control instructing the controller to control the corresponding resource based on an actual situation of surplus power and demand power of the corresponding resource. During execution of the first control, the server instructs the controller to perform the second control during a period in which at least one of power sale of the surplus power and power purchase of the demand power is predicted to occur in the corresponding resource.

A power management method according to another aspect of the present disclosure manages power supply and demand in a power grid including a plurality of power balancing resources. The power management method includes a setting step in which a server sets power management control to be performed on a corresponding resource for a controller, the corresponding resource being a corresponding one of the power balancing resources.

The power management control includes
a first control in which the server instructs the controller to control the corresponding resource based on a power supply and demand plan developed in advance, and
a second control in which the server instructs the controller to control the corresponding resource based on an actual situation of surplus power and demand power of the corresponding resource.

The setting step includes
a step of predicting whether, during execution of the first control, at least one of power sale of the surplus power and power purchase of the demand power occurs in the corresponding resource, and
a step of switching the power management control from the first control to the second control during a period in which at least one of the power sale of the surplus power and the power purchase of the demand power is predicted to occur.

According to the present disclosure, it is possible to reduce the user burden when electric power is sold and purchased in the power balancing resource.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of an overall configuration of a power management system according to an embodiment of the present disclosure;

FIG. 2 is a time chart for explaining an outline of power management control according to the present embodiment; and

FIG. 3 is a flow chart illustrating an exemplary process of power management control according to the present embodiments.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### Embodiment

### System Configuration

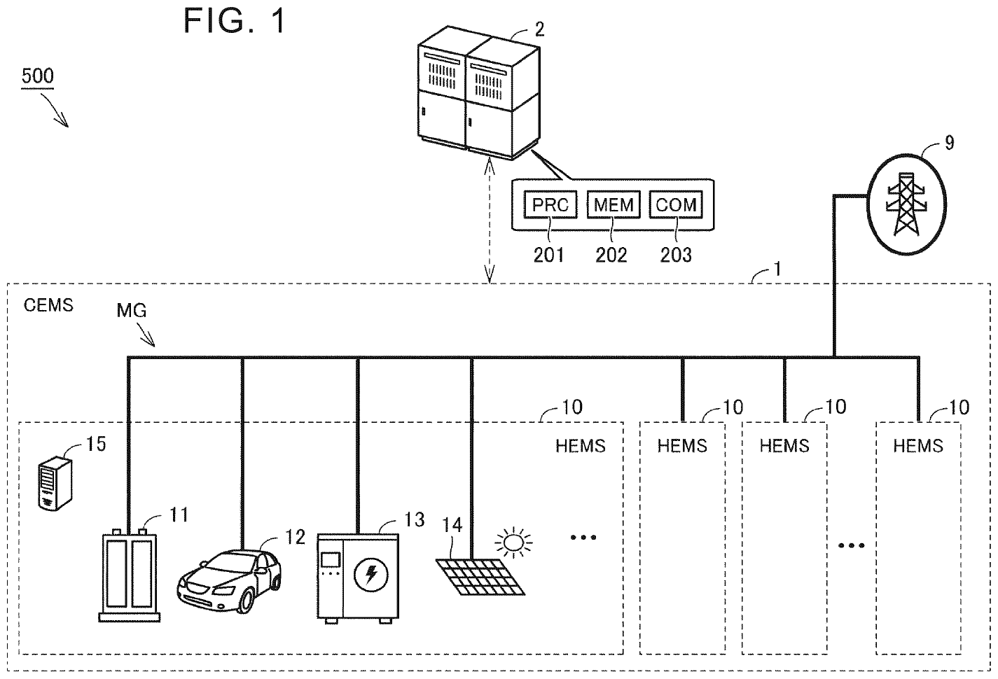

FIG. 1 is a diagram illustrating an example of an overall configuration of a power management system according to an embodiment of the present disclosure. The power management system 500 includes a CEMS 1 and an energy management server 2.

CEMS 1 means Community Energy Management System or City Energy Management System. CEMS 1 includes, for example, a plurality of Home Energy Management System (HEMS) 10. In CEMS 1, a microgrid MG is constructed by a plurality of HEMS 10. The microgrid MG is connected to the power system 9 so that power can be exchanged with the power system 9. The power system 9 is an electric power grid constructed by a power plant and a transmission and distribution facility.

Note that the microgrid MG is an exemplary “power grid” according to the present disclosure. CEMS 1 may comprise Factory Energy Management System (FEMS) or Building Energy Management System (BEMS) in place of or in addition to HEMS 10. CEMS 1 may include only one of the energy-management systems.

Each of the plurality of HEMS 10 manages power used in the home. That is, each of the plurality of HEMS 10 manages power dissipation, demand, and supply. HEMS 10 include, for example, a water heater 11, an electrified vehicle 12, a storage battery 13, a photo voltaic (PV) power generation facility 14, and HEMS controllers 15.

The water heater 11 is, for example, a water heater of a cogeneration system. The water heater of the cogeneration system may be a water heater using heat generated at the time of private power generation, or may be a heat pump water heater. The water heater 11 boils the optimum amount of hot water corresponding to the usage amount of hot water for each household at night using inexpensive midnight power, and stores the boiled water in a hot water storage tank in preparation for use on the next day (so-called boiling).

Electrified vehicle 12 is a vehicle including a battery (not shown), and specifically, plug-in hybrid electric vehicle (PHEV), battery electric vehicle (BEV), and the like. Electrified vehicle 12 is configured to receive power from the microgrid MG by connecting a charging cable extending from a charging facility (not shown) to an inlet (not shown) of electrified vehicle 12 (external charging). Electrified vehicle 12 may be configured to be dischargeable to the microgrid MG by connecting a charge cable to an outlet (not shown) of electrified vehicle 12 (external discharge). In this way, electrified vehicle 12 also functions as a movable power storage device.

The storage battery 13 is a stationary power storage device that stores electric power generated during daytime by PV power generation facility 14. The storage battery 13 may be a secondary battery such as a lithium-ion battery or a nickel-metal hydride battery, and may be manufactured using, for example, a traveling battery mounted on a vehicle in the past.

PV power generation facility 14 receives sunlight in the daytime to generate electric power, and charges the storage battery 13 with the generated electric power and outputs the electric power to the microgrid MG. HEMS 10 may instead of or in addition to PV power generation facility 14 include other naturally varying power sources, such as wind power generation facilities (power generation facilities where power generation power varies depending on weather conditions).

The above-described device is merely an example, and HEMS 10 may further include other devices (electric devices or V2H devices such as an air conditioner, a fuel cell, a lighting device, a generator, a heat storage tank, and the like) other than the above-described devices (not shown). Each device in HEMS 10 corresponds to a “power balancing resource” according to the present disclosure.

HEMS controllers 15 are configured to be able to communicate with the respective devices in HEMS 10. HEMS controllers 15 acquire the information of the respective devices and control the operation of the respective devices.

HEMS controllers 15 are also configured to communicate bi-directionally with the energy management server 2. HEMS controllers 15 transmit, to the energy management server 2, a value (power value, status value, and the like) indicating the operation status of the device acquired from the respective devices. In addition, HEMS controllers 15 control the respective devices in accordance with control commands from the energy management server 2.

The energy management server 2 is a host computer (cloud server) that integrally manages a plurality of HEMS controllers 15. The energy management server 2 includes a processor 201, a memory 202, and a communication interface 203. By reading out programs and various data (maps, relational expressions, parameters, and the like) stored in the memory 202 and expanding them into the memory 202, the processor 201 executes various processes. The communication interface 203 is configured to communicate with each of the plurality of HEMS controllers 15. The energy management server 2 performs “power management control” for each of the plurality of HEMS 10 to manage charge, power dissipation, and/or discharge in HEMS 10. This control will be described later.

Each of the plurality of HEMS controllers 15 corresponds to a “controller” according to the present disclosure. The energy management server 2 corresponds to a “server” according to the present disclosure.

### Power Management Control

For each HEMS 10 who is a customer in CEM 1, the energy management server 2 formulates a power supply and demand plan so that the electricity rate of HEMS 10 is minimized on the basis of the electricity rate unit price and the power-receiving-end power prediction of HEMS 10. Then, the energy management server 2 executes “plan control” in accordance with the power supply and demand plan for each HEMS 10. In the planning control, the control right of each device in HEMS 10 is held by the energy management server 2, and the energy management server 2 cooperatively controls each device in HEMS 10. This maximizes personal consumption in HEMS 10 and reduces (minimizes) the electricity charge.

However, the actual power supply and demand of HEMS 10 is not always able to keep the electricity rate down due to the trend of the power supply and demand planning. The behavior of a consumer on one day may differ from that of a consumer on another day (normal behavior pattern). Alternatively, the weather may change from moment to moment, or the weather may change differently than expected based on historical data. As a consequence, there is a possibility that the power generation amounts of the natural variable power sources, such as PV power generation facility 14, may change differently than predicted. In addition, it is difficult to formulate a precise power supply and demand plan with a short time granularity of, for example, one minute. Therefore, there is a possibility that sales and purchase of electric power occurs in HEMS 10, that is, a period in which HEMS 10 surplus power is sold occurs, or a period in which HEMS 10 demand power (insufficient electric power) is purchased occurs. When such a period occurs, the amount of purchased electricity and/or the amount of sold electricity may increase as compared with a case where the actual power supply and demand is always in accordance with the power supply and demand plan, and the electricity rate may increase accordingly.

Therefore, in the present embodiment, during a period in which it is predicted that trading of electric power occurs during execution of plan control, the energy management server 2 switches the power management control from “plan control” to “edge control”. In this case, the period during which electric power is predicted to be sold is a period during which surplus power is predicted to be sold by PV power generation facility 14 or during which electric power is predicted to be purchased due to an increased demand for electric power such as equipment (air conditioner, illumination device) in HEMS 10.

In the edge-control, the control rights of the respective devices in HEMS 10 are transferred from the energy management server 2 to HEMS controllers 15. HEMS controllers 15 monitor the power at the receiving end in HEMS 10. Then, HEMS controllers 15 closely control the charging and discharging of the respective devices (the water heater 11, electrified vehicle 12, and the storage battery 13 in this embodiment) in HEMS 10 in accordance with the change in the amount of electric power buying and selling at the power receiving end of HEMS 10. As a result, the amount of electric power to be sold at the power receiving end of HEMS 10 can be reduced, and the self-consumption can be maximized. Consequently, the electricity rate in HEMS 10 can be reduced.

Hereinafter, switching between the plan control and the edge control will be described in more detail. Note that the plan control corresponds to “first control” according to the present disclosure, and the edge control corresponds to “second control” according to the present disclosure.

### Switching Between Plan Control and Edge Control

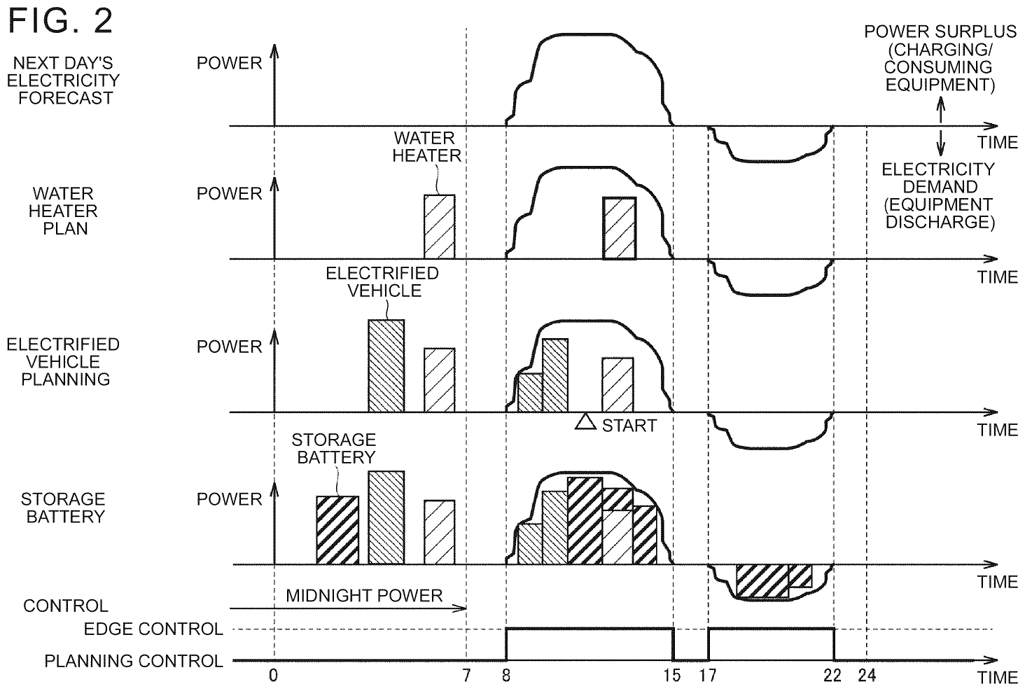

FIG. 2 is a time chart for explaining an outline of power management control in the present embodiment. The horizontal axis represents elapsed time. More specifically, the horizontal axis represents the elapsed time in a certain target period (in this example, a period from 0:00 to 24:00 on the next day). The vertical axis represents electric power (generated electric power or demand power). In FIG. 2, in order from the top, the following types of the target HEMS 10 are shown: the next-day power forecast in HEMS 10, the operation plan of the water heater 11, the operation plan of electrified vehicle 12, the operation plan of the storage battery 13, and the power management control.

For the target HEMS 10, the energy management server 2 predicts the power-receiving-end power in the target period at a predetermined timing. In this example, it is assumed that the prediction is performed at a timing of 0 o'clock, and as a result, surplus power is generated in a period from 8 o'clock to 15 o'clock, and demand power (that is, power shortage) is predicted to occur in a period from 17 o'clock to 22 o'clock. In addition, it is assumed that inexpensive midnight power can be used in a period from night to 7 o'clock.

During the period from 0:00 to 8:00, neither surplus power nor demand power is expected to be generated. Therefore, the energy management server 2 executes the plan control. Therefore, the control right of the devices in HEMS 10 is maintained by the energy management server 2.

During the period up to 7:00 of the period, the energy management server 2 performs the following control using inexpensive midnight power. First, the energy management server 2 determines the boiling-up time of the water heater 11. In this example, the energy management server 2 controls the water heater 11 so as to boil at least a part of the optimum amount of water by using the midnight power in order to boil up the optimum amount of water by 17:00, when the generation of the demand power is predicted. Second, the energy management server 2 charges electrified vehicle 12 so that SOC of electrified vehicle 12 reaches the target at the scheduled departure time of electrified vehicle 12. In this case, the energy management server 2 charges the electrified vehicle 12 to at least an intermediate SOC (e.g., SOC=60%) using the midnight power so that SOC reaches the target SOC (e.g., SOC=80%) at 12:00, which is the scheduled departure time. Third, the energy management server 2 charges the storage battery 13 using midnight power.

It is predicted that surplus power will be generated in the period from 8:00 to 15:00. Accordingly, there is a high possibility that electric power is sold at the power receiving end of HEMS 10. Therefore, the energy management server 2 switches the power management control from the plan control to the edge control. Therefore, the control rights of the devices in HEMS 10 are delegated from the energy management server 2 to HEMS controllers 15.

HEMS controllers 15 execute control so as to reduce the amount of electric power sold at the power receiving end of HEMS 10. That is, HEMS controllers 15 control the actual power consumption of HEMS 10 (the sum of the charged power or the power consumption of each device) so as to be within the surplus power range and to be as close to the surplus power as possible. In this case, first, HEMS controllers 15 charge electrified vehicle 12 so that SOC of electrified vehicle 12 reaches the target SOC by the scheduled departure time of electrified vehicle 12. That is, HEMS controllers 15 charge electrified vehicle 12 with electric power corresponding to the remaining SOC (for example, the remaining 20% from 60% to 80%) from SOC where the charging is stopped on the way to the final SOC. Further, HEMS controllers 15 execute control so as to boil up the optimum quantity of water by 17:00 when the power demand is generated. That is, HEMS controllers 15 control the water heater 11 so as to boil the remaining hot water (the difference between the optimum amount of hot water and a part of the hot water boiled using the midnight power) using the midnight power. Further, HEMS controllers 15 charge the storage battery 13 with electric power that is not charged or consumed by the water heater 11 and electrified vehicle 12 among the surplus electric power (electric power obtained by subtracting the electric power consumed by the water heater 11 and the electric power charged by electrified vehicle 12 from the surplus electric power).

During the period from 15:00 to 17:00, neither surplus power nor demand power is expected to be generated. Therefore, the energy management server 2 returns the power management control from the edge control to the plan control. Accordingly, the energy management server 2 recovers the control rights of the respective devices in HEMS 10 from HEMS controllers 15.

During the period from 17:00 to 22:00, electricity demand is expected to be generated. Accordingly, there is a high possibility that power is purchased at the receiving end of HEMS 10. Therefore, the energy management server 2 switches the power management control from the plan control to the edge control again. Therefore, the control rights of the devices in HEMS 10 are delegated from the energy management server 2 to HEMS controllers 15.

HEMS controllers 15 perform control so as to reduce the amount of power purchased at the power receiving end of HEMS 10. That is, HEMS controllers 15 control the actual supplied power (the sum of the discharged power from the respective devices) of HEMS 10 so as to be within the required power and to be as close to the required power as possible. In this embodiment, HEMS controllers 15 discharge the storage battery 13. Although not shown, if electrified vehicle 12 is returning from the outing destination, HEMS controllers 15 may discharge electrified vehicle 12.

During the period from 22:00 to 24:00, neither surplus power nor demand power is expected to be generated. Therefore, the energy management server 2 returns the power management control from the edge control to the plan control. Accordingly, the energy management server 2 recovers the control rights of the respective devices in HEMS 10 from HEMS controllers 15.

As described above, in the present embodiment, during a time period in which the sale of the surplus power or the purchase of the demand power is predicted to occur in HEMS 10, the power management control for HEMS 10 is switched from the planning control to the edge-control. Then, the control rights of the respective devices in HEMS 10 are delegated to HEMS controllers 15. This allows HEMS controllers 15 to control the respective devices in HEMS 10 while monitoring the actual power receiving end power in HEMS 10 in real time. That is, in response to a change in the power receiving end power of HEMS 10, HEMS controllers 15 can control the power (the charge power, the power consumed, and/or the discharge power) of the devices in HEMS 10 in short-time units. Therefore, according to the present embodiment, it is possible to maximize the self-consumption of HEMS 10 and thereby reduce the amount of electric power buying and selling at the power receiving end of HEMS 10. Consequently, the electricity rate in HEMS 10 can be reduced.

### Process Flow

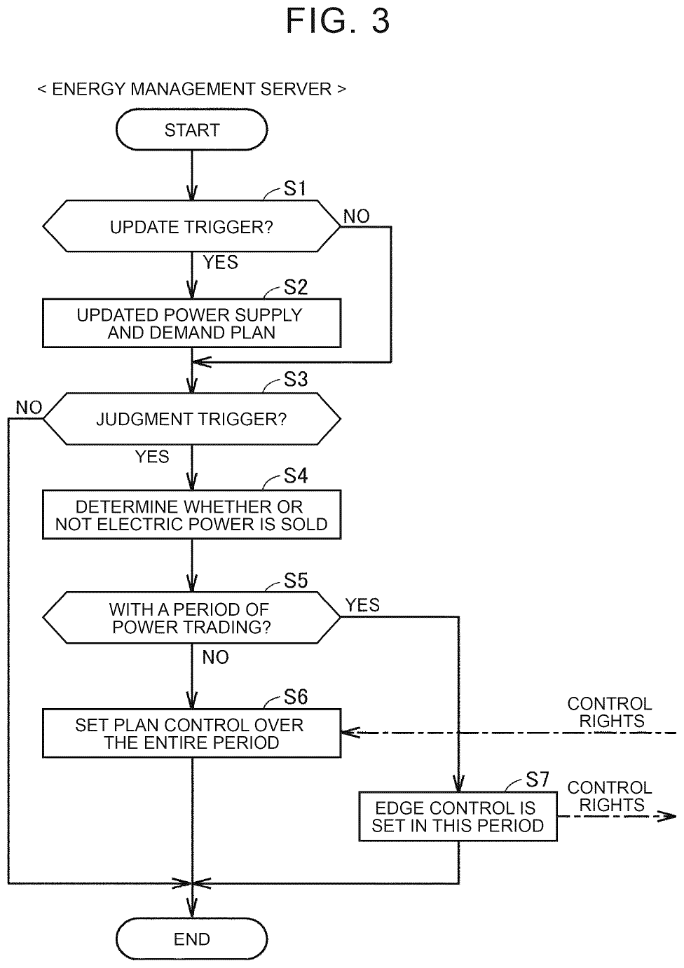

FIG. 3 is a flowchart illustrating an example of a processing procedure of power management control according to the present embodiment. The process illustrated in this flowchart is executed when a predetermined condition is satisfied (for example, every predetermined cycle) during execution of the plan control. Each step is realized by software processing by the energy management server 2, but may be realized by hardware (electric circuit) arranged in the energy management server 2. Hereinafter, the step is abbreviated as S.

In S1, the energy management server 2 determines whether or not a trigger (hereinafter referred to as “update trigger”) for updating the power supply and demand plan of the target HEMS 10 has occurred. For example, an update trigger occurs when a predetermined time arrives. Alternatively, for example, an updating trigger may be generated in accordance with a manipulation by a user of HEMS 10. An update trigger may be generated in accordance with an operation performed by an administrator of the energy management server 2. When an update trigger occurs (YES in S1), the energy management server 2 updates the power supply and demand plan of the target HEMS 10 (S2). In other words, the control content of the planning control for maximizing the in-house expenditure in HEMS 10 and minimizing the electricity rate is updated. After that, the energy management server 2 advances the process to S3. If no updating trigger has occurred (NO in S1), S2 process is skipped and the process proceeds to S3.

In S3, the energy management server 2 determines whether or not a trigger (hereinafter, referred to as “determination trigger”) for determining whether or not there is a buying or selling of electric power has occurred for the target HEMS 10. The determination trigger also occurs periodically, for example, when a predetermined time arrives. Further, the determination trigger may be generated every time the update trigger occurs (that is, every time the power supply and demand plan is updated).

When the determination trigger is generated (YES in S3), the energy management server 2 determines whether or not at least one of the sale of the surplus power and the purchase of the demand power is predicted to occur over the target period (S4). For example, the energy management server 2 determines whether a period exceeding the power that can be consumed or stored in HEMS 10 is generated due to an increase in the power generated by PV power generation facility 14, or a period in which the power generated by PV power generation facility 14 cannot cover the power required in HEMS 10 is generated. The energy management server 2 determines based on the latest conditions of devices in HEMS 10 (e.g., changes in the energy storage conditions of the water heater 11, electrified vehicle 12, and the storage battery 13), the latest actions of consumers (e.g., increases or decreases in power consumed by various electric appliances), the latest weather information (particularly, the amount of solar radiation), and the like.

When it is predicted that neither the period during which the surplus power is sold nor the period during which the demand power is purchased is expected to occur (NO in S5), the energy management server 2 sets the power management control to the planning control over the entire period of the target period (S6). The control right of HEMS 10 is held in the energy management server 2 over the entire period.

On the other hand, when it is predicted that the surplus power is sold or the demand power is purchased somewhere in the target period (YES in S5), the energy management server 2 sets the power management control to the edge-control for a period in which the generation of the surplus power selling and/or the purchase of the demand power is predicted (S7). As a result, HEMS 10 control right is delegated from the energy management server 2 to HEMS controllers 15. The power management control for a period other than the above is set to the plan control. As a result, HEMS 10 control rights are returned from HEMS controllers 15 to the energy management server 2. The energy management server 2 may return the power management control of HEMS 10 to the planning control during the period in which it is predicted that neither the sale of the surplus power nor the purchase of the demand power occurs during the edge control.

As described above, in the present embodiment, the power management control is set to the edge control and the control rights of the respective devices in HEMS 10 are delegated to HEMS controllers 15 during the time period in which the sale of the surplus power and/or the purchase of the demand power are predicted to occur in HEMS 10. Then, HEMS controllers 15 can control the respective devices while monitoring the power receiving end power of HEMS 10 in real time. HEMS controllers 15 can maximize HEMS 10's self-consumption by closely controlling the power of the respective devices in accordance with the change in the power receiving end power of HEMS 10. As a result, it is possible to reduce the amount of electric power buying and selling at the power receiving end of HEMS 10. In addition, when the edge control is set at all times, the charging and discharging of the device in HEMS 10 can be switched frequently, and by executing the edge control only during a period in which the generation of the electric power selling of the surplus electric power and/or the purchase of the electric power demand is predicted, the electric power loss associated with such switching can be suppressed. Therefore, according to the present embodiment, the electricity rate in HEMS 10 can be reduced, and the burden on the user of HEMS 10 can be reduced.

In FIG. 2, it has been described that the water heater 11, electrified vehicle 12, and the storage battery 13 are devices to be controlled for switching between the planning control and the edge control. Controlling the water heater 11 so as to boil an optimum amount of water using inexpensive midnight electric power has a particularly large merit of personal consumption. Therefore, the water heater 11 has the highest priority order as a control target device. Since electrified vehicle 12 has a scheduled departure time or needs to be charged so as not to lose power at the place of going out, it is not possible to freely perform charging and discharging with respect to electrified vehicle 12. Although charge/discharge is conditioned so as not to reduce the convenience of the user as described above, the battery capacity of electrified vehicle 12 is also sufficiently large, so that the contribution to personal consumption is large. In many cases, the storage battery 13 has a larger capacity than electrified vehicle 12. In addition, the storage battery 13 has high control flexibility in that it does not result in a decrease in user convenience. The device to be controlled is not limited to the above three types of devices, and may include, for example, a fuel cell.

In addition, the air conditioner and the lighting device are not suitable as control target devices. This is because, when the temperature, the brightness, or the like in the room is controlled against the user operation, the comfort for the user may be hindered. Also, PV power generation facility 14 is not suitable as a control target device. This is because when the power generation is suppressed by controlling PV power generation facility 14, an economical disadvantage (reduction in the electric power selling fee) can be brought to the user.

It is to be understood that the embodiments disclosed herein are illustrative and non-restrictive in all respects. It is intended that the scope of the disclosure be defined by the appended claims rather than the description of the embodiments described above, and that all changes within the meaning and range of equivalency of the claims be embraced therein.

What is claimed is:

1. A power management system that manages power supply and demand in a power grid including a plurality of power balancing resources, the power management system comprising:
a controller that controls a corresponding resource that is a corresponding one of the power balancing resources; and
a server that sets power management control to be performed on the corresponding resource by the controller, wherein:
the power management control includes
a first control instructing the controller to control the corresponding resource based on a power supply and demand plan developed in advance, and
a second control instructing the controller to control the corresponding resource based on an actual situation of surplus power and demand power of the corresponding resource; and
during execution of the first control, the server instructs the controller to perform the second control during a period in which at least one of power sale of the surplus power and power purchase of the demand power is predicted to occur in the corresponding resource.

2. The power management system according to claim 1, wherein during execution of the second control, the server instructs the controller to perform the first control during a period in which neither the power sale of the surplus power nor the power purchase of the demand power is predicted to occur.

3. The power management system according to claim 2, wherein while the server has a control right of the corresponding resource in the first control, the server transfers the control right to the controller in the second control.

4. The power management system according to claim 1, wherein:
each of the power balancing resources belongs to either of a first group and a second group;
the first group includes at least one of a water heater, an electrified vehicle, a storage battery, and a fuel cell;
the second group includes at least one of an air conditioner, a lighting device, and a photovoltaic power generation facility; and
while the server sets, among the power balancing resources, a power balancing resource belonging to the first group as a control target of the first control and the second control, the server does not set, among the power balancing resources, a power balancing resource belonging to the second group as the control target.

5. A power management method for managing power supply and demand in a power grid including a plurality of power balancing resources, the power management method comprising a setting step in which a server sets power management control to be performed on a corresponding resource for a controller, the corresponding resource being a corresponding one of the power balancing resources, wherein:
the power management control includes
a first control in which the server instructs the controller to control the corresponding resource based on a power supply and demand plan developed in advance, and
a second control in which the server instructs the controller to control the corresponding resource based on an actual situation of surplus power and demand power of the corresponding resource; and
the setting step includes
a step of predicting whether, during execution of the first control, at least one of power sale of the surplus power and power purchase of the demand power occurs in the corresponding resource, and
a step of switching the power management control from the first control to the second control during a period in which at least one of the power sale of the surplus power and the power purchase of the demand power is predicted to occur.
